(19) United States
(12) Patent Application Publication
(10) Pub. No.: US 2006/0285833 A1
(43) Pub. Date: Dec. 21, 2006

(54) Method for manufacturing audio visual productions

(76) Inventor: Johannes M.C.W. de Haas, Breda (NL)

Correspondence Address: MCDERMOTT, WILL & EMERY LLP, 227 WEST MONROE STREET, CHICAGO, IL, 60606-5096, US

(21) Appl. No.: 11/284,007

(22) Filed: Nov. 21, 2005

(30) Foreign Application Priority Data
Jun. 17, 2005 (EP) 05076425.7

(51) Int. Cl. H04N 5/00

(52) U.S. Cl. 386/117

(57) ABSTRACT

The invention has the aim to process image and sound material recorded with a camera by means of a new inventive workflow, the so called Penta workflow, digital tape or hard disk raid according to HD 4:4:4 standard directly via a specific interface, the duallink system, in an HD-machine, by which the elapsed time of cinematographic material is strongly limited in a surprisingly way, in which the recording and processing equipment is placed as a mobile composition in a van and by which with the above described mobile composition more audiovisual material with a high quality can be produced within the existing budget.

### TECHNICAL FIELD

The present invention relates to a method to convert image and sound material, recorded with a camera by means of a procedure, called workflow, in an electronic way into several cinematographic, television and multimedia productions and such, in which the mentioned camera applies the image and sound material on a digital tape or hard disk raid HD 4:4:4 or HD 4:2:2, in which the recorded material is edited, processed or mixed to the required audiovisual products in a so called elapsed time, in which due to high cost for used material and material, actors, concerned executive and supporting persons and such, especially the elapsed time must be limited in order to produce as much audiovisual productions as possible within the available budgets.

### BACKGROUND OF THE INVENTION

In the present practice a number of mentioned workflows are used, which are rather time consuming and with that demand a lot of personnel handlings, so that the audiovisual end product becomes rather expensive and with the generally not too large budgets a smaller number of audiovisual productions can be made. Below, three used workflows are described in short.

WORKFLOW 1:

The camera operator records from his camera onto a digital tape (high-grade quality tape for recording film and sound) of type HD 4:4:4 or HD 4:2:2 (high Definition),in which with the digital tape HD 4:4:4 all colors are directly compressed recorded and with the digital tape HD 4:2:2 the colors are compressed, through which the colors red and blue are recorded for a limited degree and by which a loss of color pixels occurs. Following, the mentioned digital tape is conveyed to a unit where it is read in. The mentioned reading-in is done on a hard disk raid (=a series of coupled hard disks) and is further recorded in a SAN-drive (=library consisting of hard disks from which one can centrally pick up data via the mentioned network. Then the file HD 4:4:4 is processed and the file HD 4:2:2 is decompressed or unpacked. Following, the digitape is processed off-line (=processing material from a copy and then write back) or on-line (=processing material in its original without having to write back). After the above described process of the digital tape, the files are mixed (=written away in the correct format).

Schematically, in handling/processing and needed time for 5 minutes of recorded time looks as follows in workflow 1:

WORKFLOW 1:

| | ELAPSED TIME |
|---|---|
| HANDLING/PROCESSING | (IN MINUTES) |
| Camera operator | Variable |
| Tape | 15′ |
| Tape operator | 15′ |
| Video assistant | 15′ |
| Courier | Variable |
| Day 2: | |
| Digital operator | 180′ |
| Editor | 120′ |
| Viewing | 120′ |
| Saving | 60′ |

WORKFLOW 2:

The mentioned camera recordings go to a hard disk raid HD 4:4:4 or HD 4:2:2. Transport from hard disk raid (=a set of hard disks on the camera) to process unit for reading-in to SAN-drive (for explanation see workflow 1). Following, processing hard disk raid HD 4:4:4 or decompressing hard disk raid HD 4:2:2. Then the off-line or on-line processing takes place, after which the mixing of the file on the hard disk to the required format is executed.

Schematically, in handling/processing and needed time for 5 minutes of recorded time looks as follows in workflow 2:

WORKFLOW 2:

| | ELAPSED TIME |
|---|---|
| HANDLING/PROCESSING | (IN MINUTES) |
| Camera operator | Variable |
| Disk raid | 60′ |
| Disk operator | 15′ |
| Courier | Variable |
| Day 2 | |
| Disk operator | 30′ |
| Editor | 120′ |
| Viewing | 120′ |
| Saving | 60′ |

WORKFLOW 3:

The mentioned camera recordings on 16 mm or 35 mm film are physically transported to the development studio. In the mentioned development studio the film is scanned, read in on bard disk and written to a SAN-drive. Following, the file is processed, which can be done off-line or on-line (for example with special effects, executing extra editing and such). After processing, the so called extraction takes place (=calculation with the computer of the edits on the material and processing it, in which the speed is computer dependable) to the required format and carrier (given by the client) writing away and putting back on film.

Schematically, in handling/processing and needed time for 5 minutes of recorded time looks as follows in workflow 3:

WORKFLOW 3:

| | ELAPSED TIME |
|---|---|
| HANDLING/PROCESSING | (IN MINUTES) |
| Camera operator | Variable |
| Film | 15′ |
| Courier | Variable |
| Day 2: | |
| Developing | 120′ |
| Courier | Variable |
| Day 3: | |
| Digital scan operator | 60′ |
| Editing | 120′ |
| Viewing | 120′ |
| Saving | 60′ |

None of the previous described “workflows” allow playback of a video or a film immediately on the set for approval by the director, producer and/or actors.

Further it must be noted, that when working with compressed material, or when scanning in or out from cellulose tape, a lot of finishing must be done for the addition of missed material (so called “pixel loss” on HD 4:2:2).

The above shows, that the existing or known “workflows” for processing image and sound material on tape to finished audiovisual productions have a number of disadvantages that prevent many audiovisual productions from being produced within the limits of the available budgets, including the spent time, personnel efforts, and material with accompanying cost. Also, for the director and producer it is a great advantage to be able to watch the recordings sooner.

### SUMMARY OF THE INVENTION

It is the aim of the present invention to develop or modify such a “workflow”, the so called Penta Workflow from the described workflows 1, 2, 3 to provide a very efficient way to make audiovisual productions.

For this, a method, being a workflow, called Penta Workflow is further developed and/or modified in a very inventive way, characterized in that the image and sound material of the recording camera with digital tape or hard disk raid according to HD 4:4:4 standard is directly processed to the required audiovisual product by means of a connected specific interface thereon in a connected HD-processing machine thereon.

The advantage is that, the camera operator makes camera recordings with a so called HD 4:4:4, which is sent directly to an HD-processing machine, which is mobile or movable present on the set. In the HD-processing machine one can process the file of recordings on-line, according to extraction and after that mixing to a required format.

### BRIEF DESCRIPTION OF DRAWINGS

FIG. 1 is a schematic of an HD processing system.

### DETAILED DESCRIPTION OF DRAWINGS

It is the aim of the present invention to develop or modify such a “workflow”, the so called Penta Workflow from the described workflows 1, 2, 3 to provide a very efficient way to make audiovisual productions.

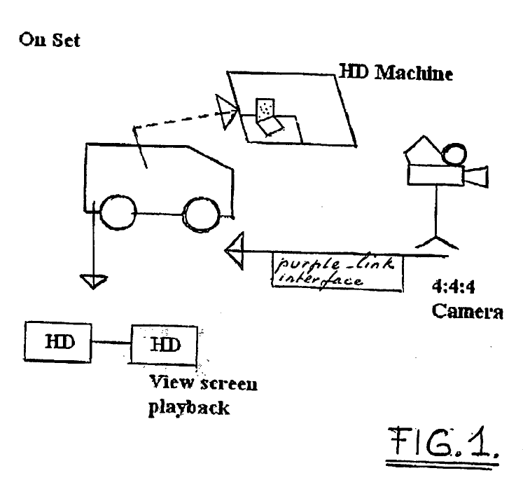

For this, a method, being a workflow, called Penta Workflow is further developed and/or modified in a very inventive way, characterized in that the image and sound material of the recording camera 10 with digital tape or hard disk raid according to HD 4:4:4 standard is directly processed to the required audiovisual product by means of a connected specific interface thereon 12 in a connected HD-processing machine thereon 14, as shown in FIG. 1.

The advantage is that, the camera operator makes camera recordings with a so called HD 4:4:4, which is sent directly to an HD-processing machine 14, which is mobile or movable present on the set. In the HD-processing machine 14 one can process the file of recordings on-line, according to extraction and after that mixing to a required format.

So, schematically the Penta Workflow in handling and/or processing and with that the needed time for, for example, 5 minutes of recorded time looks as follows:

| | ELAPSED TIME |
|---|---|
| HANDLING/PROCESSING | (IN MINUTES) |
| Camera operator | Variable |
| HD-machine | 0′ |
| Editor | 30′ |
| Viewing | 60′ |
| Extraction | Variable |
| Mixing | 30′ |

The advantages of the Penta Workflow are further detailed as follows:

The camera operator sends the recordings, being the image and sound material directly to the HD-machine 14, by which:
there is no material loss
there is no quality loss
a number of “double” handlings do not have to be executed anymore.

The HD-machine 14 can immediately perform all processes, which are needed to let the “crew” and the “cast” do a final check on the spot and then can continue to the next scene, thus, by which there is no time-loss and for the benefit of the budget, it is of importance that no overrunning of the production schedule occurs.

The editor can do a lot of preliminary editing on the set and in the mobile unit, before the end-phase. The work can be immediately viewed, for example on a playback view screen 16, as shown in FIG. 1, by the executive parties, and afterwards the editor can then extract and possibly, if required, write it away completely.

The result is, that an efficient workflow (the Penta Workflow) can be guaranteed and not only a lot more productions are recorded, but automatically more people can be employed (cast as well as crew), by which the employment in the field becomes larger and productions can be financed a lot easier.

Further, the method according to the invention is further developed in such a way, that the image and sound material recorded with the mentioned camera 10 according to the HD 4:4:4 standard is directly sent by cable guides to the mentioned specific interface 12, which specific interface 12 is integrated in the mentioned HD-machine 14.

The advantage is, that there is no loss in quality of the material in any forms and the material is immediately ready for processing.

Furthermore, the method according to the invention is further developed in such a way, that the mentioned specific interface 12 works according to the duallink system.

The advantage of the specific interface 12 is, that the systems can communicate with each other immediately.

Furthermore, the method according to the invention is further developed in such a way, that the mentioned HD-machine 14 works according to the uncompressed on-line method, such as, for example, Quantel eQ.

The advantage is, that the mentioned HD-machine 14 does all the handlings, which must normally be done physically, so that workers can be used much more efficient than before. Also, the material, is at once ready for every process and all these processes can be done with the same machine 14.

Furthermore, the method according to the invention is further developed in such a way, that for the mentioned camera 10, which works according to the standard HD 4:4:4, for example, a Thomson Viper Filmstream Camera for uncompressed cinematography is chosen.

The advantage is, a much better quality of the image and sound material for the finishing and the fast obtaining thereof.

Furthermore, the method according to the invention is further developed in such a way, that the mentioned specific interface 12 according to the duallink system with adjusted booster is placed in a combined box, called “purple”-link.

The advantage is an interface 12, by which it is much easier to let the systems communicate with each other immediately.

Furthermore, the method according to the invention is further developed in such a way, that with the mentioned HD-machines 14 the next specifications of uncompressed 4:4:4 HD-RGB240 min storage are met, such as, for example, the Quantel eQ EIGER.

The advantage, when sticking to this minimum configuration, is that the method gives enough guarantees to be executed correctly.

Furthermore, a device for executing the method according to the invention is further developed in such a way, that the camera 10 is connected with the specific interface 12 by cables and/or wiring according to the standard HD 4:4:4, and is further integrated with the mentioned HD-machine 14, together with voltage sources and such and is built-in in a company van 18.

The advantage is a mobile composition of recording and processing equipment, which is placed inside a van 18, as schematically shown in FIG. 1.

Finally it has to be emphasized, that the above description constitutes a preferred embodiment of the method of the invention and that further variations and modifications are still possible without departing the scope of this patent description.

1-9. (canceled)

10. A method to convert image and sound material, recorded with a camera, in which the camera records the audiovisual material on a digital tape or hard disk raid HD 4:4:4 or HD 4:2:2, the method comprising the step of:
directly processing the audiovisual material using a HD-processing machine connected to the camera by an interface.

11. The method of claim 10, wherein the audiovisual material is sent by cable from the camera directly to the interface, which is integrated in the HD-machine.

12. The method of claim 11, wherein the interface uses the duallink system.

13. The method of claim 12, wherein the duallink interface includes an adjusted booster.

14. The method of claim 13, wherein the HD-machine processes the audiovisual material in uncompressed 4:4:4 HD-RGB format.

15. The method of claim 10, wherein the audiovisual material is uncompressed and processed online by the HD-machine.

16. The method of claim 10, wherein the camera is a Thomson Viper Filmstream Camera for uncompressed cinematography.

17. An HD 4:4:4 audiovisual processing device built in to a mobile unit comprising:
an interface;
a camera connected to the interface; and
an HD-machine connected to the interface.

18. The device of claim 17, wherein the mobile unit is equipped according to the given specifications of a company specialized in this field to guarantee reliability and ergonomics.

19. The device of claim 17 wherein the camera is connected to the interface by cables or wiring.
